(19) United States
(12) Patent Application Publication
(10) Pub. No.: US 2017/0200127 A1
(43) Pub. Date: Jul. 13, 2017

(54) DYNAMIC MAP BASED COLLABORATIVE CALENDAR

(71) Applicant: International Business Machines Corporation, Armonk, NY (US)

(72) Inventors: Amol A. Dhondse, Pune (IN); Ana Paola Hentze Veerkamp, Mexico City (MX); Selene Margarita Orozco Nuñez, Zapopan (MX); Anand Pikle, Pune (IN); Gandhi Sivakumar, Melbourne (AU)

(21) Appl. No.: 14/990,040

(22) Filed: Jan. 7, 2016

(51) Int. Cl. G06Q 10/10; G06F 3/0482

(52) U.S. Cl. CPC G06Q 10/1095; G06F 3/0482

(57) ABSTRACT

Configuring and providing suggestions for scheduling appointments for a user through a multi-dimensional dynamic scheduler framework connected to a data correlations framework which collects data from various sources.

### BACKGROUND

The present invention relates to scheduling of appointments stored in a calendar, and more specifically to providing a calendar with dynamic map based scheduling suggestions based on correlations.

Calendars used today are largely static and are based on a set of predefined parameters. Calendars based on a set of predefined parameters do not provide scheduling dynamically based on correlations, interests, profession, and other factors based on location.

Data from various sources is currently being used personalize data provided to a user, taking into account the user's preferences and interests. The data may be internal, such as internal sources describing a customer profile or called from call center, or external, such as social forums and pertaining to service quality.

While data may be collected regarding certain actions taken by a user, this data is not used for suggesting or scheduling appointments based on the user's location and time constraints.

### SUMMARY

According to one embodiment of the present invention, a method of configuring and providing suggestions for scheduling appointments for a user through a multi-dimensional dynamic scheduler framework connected to a data correlations framework which collects data from various sources is disclosed. The method comprising the steps of: the computer retrieving a user's interests and preferences from a repository; the computer retrieving a user's contacts and information regarding the contacts' interests and preferences from the repository; the computer displaying scheduling suggestions to the user for appointments based on correlations between the user's interests and preferences and the interests and preferences of at least one of the user's contacts and locations of the user and the at least one contact; and if the computer receives an acceptance of a scheduling suggestion, the computer scheduling the suggested appointment on the user's calendar.

According to another embodiment of the present invention, a computer program product configuring and providing suggestions for scheduling appointments for a user through a multi-dimensional dynamic scheduler framework connected to a data correlations framework which collects data from various sources with a computer. The computer comprising at least one processor, one or more memories, one or more computer readable storage media. The computer program product comprising a computer readable storage medium having program instructions embodied therewith, the program instructions executable by the computer to perform a method comprising: retrieving, by the computer, a user's interests and preferences from a repository; retrieving, by the computer, a user's contacts and information regarding the contacts' interests and preferences from the repository; displaying, by the computer, scheduling suggestions to the user for appointments based on correlations between the user's interests and preferences and the interests and preferences of at least one of the user's contacts and locations of the user and the at least one contact; and if the computer receives an acceptance of a scheduling suggestion, scheduling, by the computer, the suggested appointment on the user's calendar.

A computer system for scheduling appointments for a user through a multi-dimensional dynamic scheduler framework connected to a data correlations framework which collects data from various sources. The computer system comprising a computer comprising at least one processor, one or more memories, one or more computer readable storage media having program instructions executable by the computer to perform the program instructions. The program instructions comprising: retrieving, by the computer, a user's interests and preferences from a repository; retrieving, by the computer, a user's contacts and information regarding the contacts' interests and preferences from the repository; displaying, by the computer, scheduling suggestions to the user for appointments based on correlations between the user's interests and preferences and the interests and preferences of at least one of the user's contacts and locations of the user and the at least one contact; and if the computer receives an acceptance of a scheduling suggestion, scheduling, by the computer, the suggested appointment on the user's calendar.

### BRIEF DESCRIPTION OF THE DRAWINGS

FIG. 1 depicts an exemplary diagram of a possible data processing environment in which illustrative embodiments may be implemented.

FIG. 2 shows a schematic of a multi-dimensional dynamic scheduler framework connected to a data correlations framework.

FIGS. 3A-3B show a flow diagram of a method of configuring and receiving suggestions.

FIGS. 4A-4B show a flow diagram of a method of providing scheduling suggestions.

FIG. 5 illustrates internal and external components of a client or device computer and a server computer in which illustrative embodiments may be implemented.

### DETAILED DESCRIPTION

In an embodiment of the present invention, interests of a user are used to leverage data correlations from different data sources to schedule dynamic meeting requests to individuals based on real time and location.

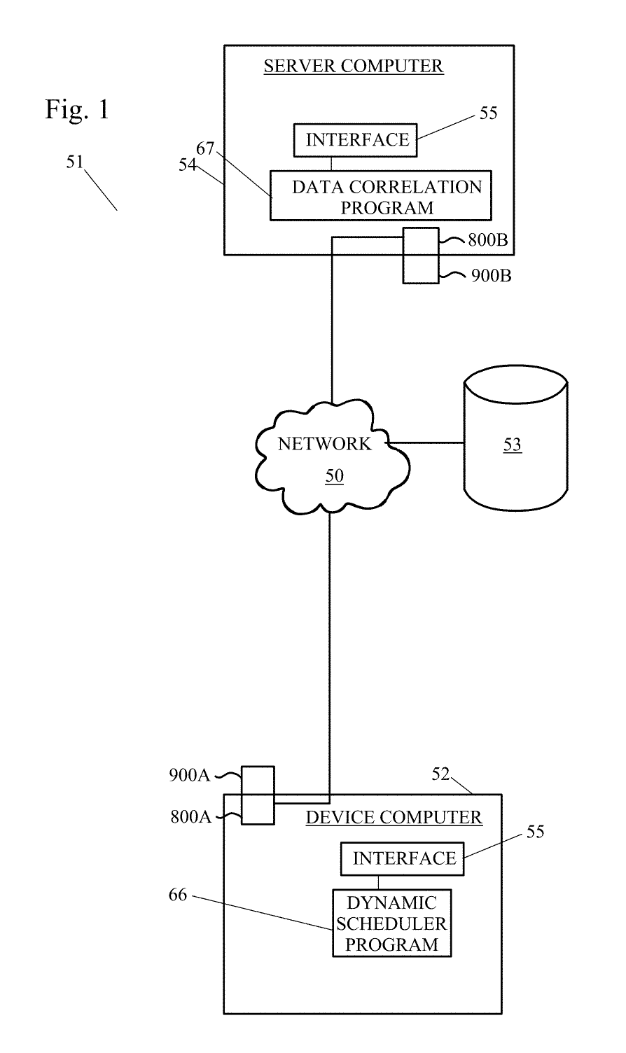

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

In the depicted example, client computer 52, storage unit 53, and server computer 54 connect to network 50. In other exemplary embodiments, network data processing system 51 may include additional client computers, storage devices, server computers, and other devices not shown.

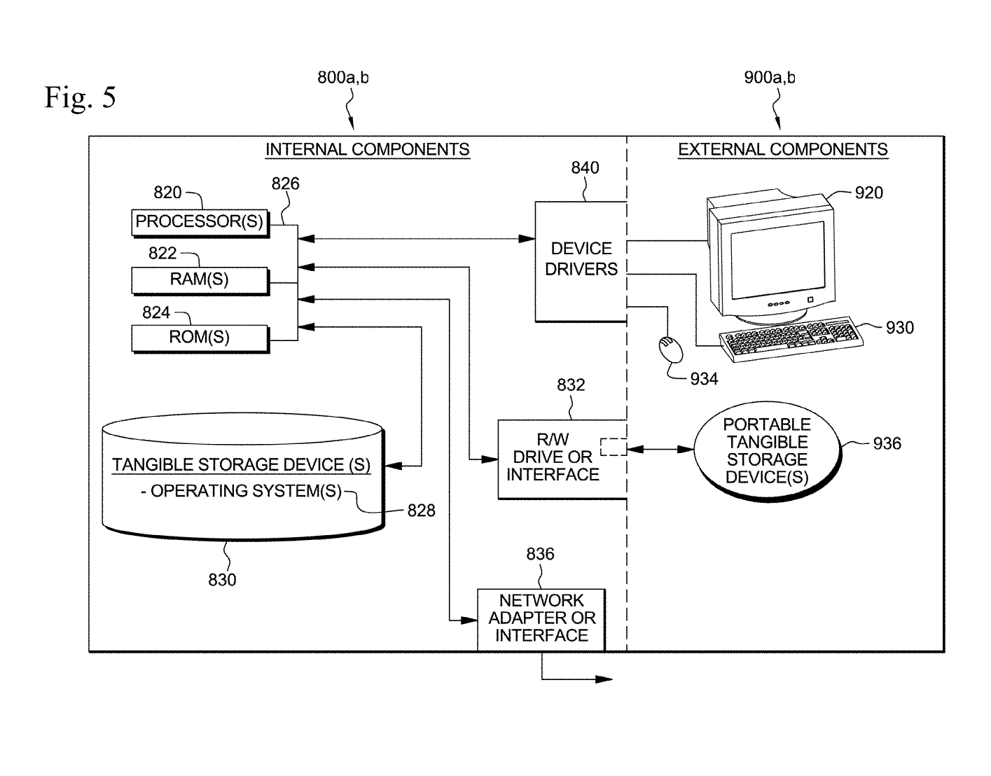

Device computer 52 includes a set of internal components 800a and a set of external components 900a, further illustrated in FIG. 5. Device computer 52 may be, for example, a mobile device, a cell phone, a personal digital assistant, a netbook, a laptop computer, a tablet computer, a desktop computer, or any other type of computing device. Device computer 52 may contain an interface 55. The interface 55 may accept commands and data entry from a user. The interface 55 can be, for example, a command line interface, a graphical user interface (GUI), or a web user interface (WUI) through which a user can access a schedule to input, reschedule or delete appointments, data regarding appointments or schedule, view the schedule, submit queries, and a dynamic scheduler program 66. Additionally, through interface 55, any representation, for example schedules and appointments may be displayed to a user.

Server computer 54 includes a set of internal components 800b and a set of external components 900b illustrated in FIG. 5. In the depicted example, server computer 54 provides information, such as boot files, operating system images, and applications to device computer 52. Server computer 54 can compute the information locally or extract the information from other computers on network 50. The server computer 54 preferably includes a data correlation program 67. The server computer 54 may contain an interface 57. Additionally, through interface 57, any representation, for example profiles associated with data correlations may be shown, queried or accessed. Interface 57 may accept commands and data entry from a data correlations framework 120 and a multi-dimensional dynamic scheduler framework 100 as well as from other various sources. Interface 57 can be, for example, a command line interface, a graphical user interface (GUI), or a web user interface (WUI) through which a user can access the data correlation program 67 on a server computer 54, as shown in FIG. 1, or alternatively on device computer 52.

Program code, schedules, appointments, data regarding the appointments or the schedule, and programs such as dynamic scheduler program 66 and data correlation program 67 may be stored on at least one of one or more computer-readable tangible storage devices 830 shown in FIG. 5, on at least one of one or more portable computer-readable tangible storage devices 936 as shown in FIG. 5, or on storage unit 53 connected to network 50, or may be downloaded to a computer, such as device computer 52 or server computer 54, for use. For example, program code, schedules, appointments, data regarding appointments or the schedule, data correlation program 67, dynamic scheduler program 66 may be stored on at least one of one or more storage devices 830 on server computer 54 and downloaded to device computer 52 over network 50 for use on device computer 52.

Alternatively, server computer 54 can be a web server, and the program code, schedules, appointments, data regarding appointments or the schedule, and programs such as data correlation program 67 and dynamic scheduler program 66 may be stored on at least one of the one or more storage devices 830 on server computer 54 and accessed on device computer 52. In other exemplary embodiments, the program code, schedules, appointments, data regarding appointments or the schedule, and programs such as dynamic scheduler program 66 and data correlation program 67 may be stored on at least one of one or more computer-readable storage devices 830 on device computer 52 or distributed between two or more servers.

In the depicted example, network data processing system 51 is the Internet with network 50 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 1 is intended as an example, and not as an architectural limitation, for the different illustrative embodiments.

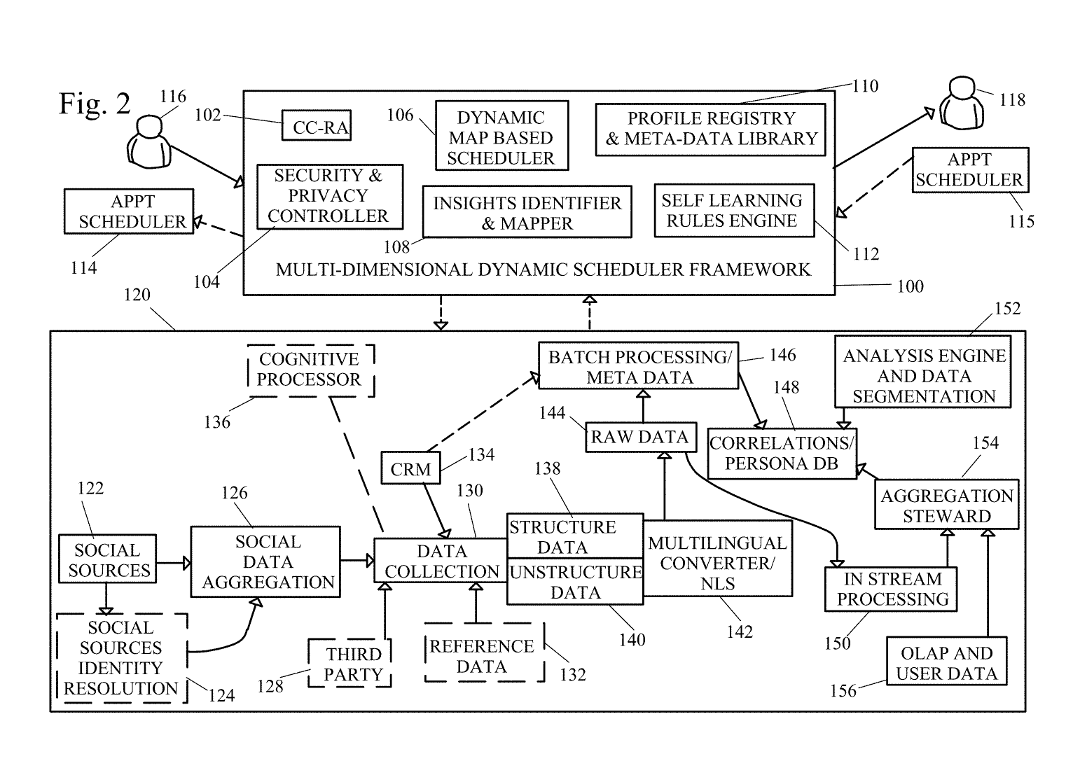

FIG. 2 shows a schematic of a multi-dimensional dynamic scheduler framework connected to a data correlations framework.

Users 116, 118 and their associated appointment schedulers 114, 115 are connected to a multi-dimensional dynamic scheduler framework 100. The multi-dimensional dynamic scheduler framework 100 receives data from a big data correlations framework 120 which aids in making scheduling recommendations to users 116, 118. The data correlations framework 120 provides a framework to gather correlations from multiple sources as well as associations/linkages to various subjects in the context of a user's profile, location of the user, availability of the user and other correlations. It should be noted that the dynamic scheduler program 66 may interact with the elements of the multi-dimensional dynamic scheduler framework 100 and the user's appointment scheduler 114, 115 and/or the user's calendars.

The multi-dimensional dynamic scheduler framework 100 preferably includes a security and privacy controller 104, dynamic map based scheduler 106, correlations identifier and mapper 108, self-learning rules engine 112, profile registry and meta-data library 110, and a Correlations-based Calendar Runtime Assistant (CC-RA) 102. Other programs may also be present in the framework 100.

The security and privacy controller 104 maintains the security integrity of the user by providing the capability to access user privacy settings for dynamic appointments where location and time can be restricted, such that a user's calendar or appointments may only be visible for certain users, including user within the same network as well as security settings based on social network relationships with predefined groups or circles, such as professional, school friends, family, and other groups.

The profile registry and meta-data library 110 includes user preferences and previous actions allowing enhancement of users' interests based on data correlations from multiple sources.

The correlations identifier and mapper 108 provides an ability to reference or leverage user interest categories and social correlations library from the data correlations framework 120 as well as a map-based GUI to define boundaries of a location and time, along with other interests & professional categories (e.g. photography, sales, travel, doctor etc. . . . ). The interests & professional categories may be tagged to groups in other networks of which the user is a part.

The self-learning rules engine 112 allows for self-learning based on correlations from different sources provided by the data correlations framework 120, to augment predefined groups, circles in the network, location and time to schedule/receive appointments.

The dynamic map based scheduler 106 provides the ability to dynamically enhance users' interest groups based on data correlations. The dynamic map based scheduler 106 also defines a virtual boundary for sending/scheduling/receiving appointments based on location where a user is going to travel and sync with a user's own calendar. Additionally, the dynamic map based scheduler 106 dynamically schedules calendar events/reminders for individuals based on interest groups with the dimension of time and location.

The CC-RA 102 displays suggestions of appointments/events/collaboration based on correlations and may prompts the user to schedule appointments/events/collaboration based on those correlations. The CC-RA 102 may also include a correlations calendar configuration steward (CC-CS) which aids in configuration of the calendar.

It should be noted that a user's profile registry, user preferences, contact information, user ratings of suggestions, and privacy settings may all be stored in a repository of the multi-dimensional dynamic scheduler framework 100. The repository may be repository 53 of FIG. 1. In an alternate embodiment, the user's profile registry, user preferences, contact information, user ratings of suggestions, and privacy settings may be stored in separate repositories.

The data correlations framework 120 provides correlations from various sources to the multi-dimensional dynamic scheduler framework 100. It should be noted that a data correlation program may interact with the data correlations framework 120 to provide correlations to the multi-dimensional dynamic scheduler framework 100.

Social sources 122 may provide data to social sources identity resolution 124. Data from the social sources 122 and social source identity resolution 124 is aggregated 126 and the output is provided to a data collection program 130.

The data collection program receives additional input from a third party source 128, reference data 132 and customer relationship management (CRM) 134. The data collection program 130 includes structural data 138 and unstructured data 140 as well as a multilingual converter/natural language support (NLS) 142. A cognitive processor 136 may be used in collected the data 130.

The raw data 144 of the data collection program 130 may be provided for batch processing 146. Additional input may be received for batch processing from CRM 134. The output or metadata from the batch processing 146 may be provided as input to the correlations/persona database 148. Additional input to the correlations/persona database 148 may be provided by the analysis engine and data segmentation 152 and the aggregation steward 154. The aggregation steward 154 may receive input from in stream processing 150 and online analytical processing and user data 156. Additionally, the in stream processing 150 may receive input from the raw data 144, and other social data from external resources.

Data maps from multiple sources of the data correlations framework 120 to create a multi-dimensional mapping to the user profile in the profile registry and meta-data library 110 of the multi-dimensional dynamic scheduler framework 100, along with the ability to create linkages to specific subject areas that are in the context user profiles and correlations from processing big-data from the data correlations framework 120.

The correlations/persona database 148 of the data correlations framework 120 processes structured 138 as well as unstructured data 140 from data collection to create object maps based on business rules that is provided as input to the correlations identifier and mapper 108 of the multi-dimensional dynamic scheduler framework 100. Additionally, the correlations/persona database 148 is able to provide accuracy of correlations/outcomes based on relevance of reference information from multiple sources.

The data correlations framework 120 can query, gather and aggregate user attributes in an asynchronous manner using open standards API (such as oAuth, openId, etc.) to augment each participating user's persona details from multiple sources 122, 128, 132, provide this information to the self-learning rules engine 112 of the multi-dimensional dynamic scheduler framework 100.

Collaboration engine invokes a background process gathers all the relevant information based on the correlations and augmented data from multiple sources and pushes it to the graphical interface.

The framework initiates a run-time framework called Correlations-based Calendar Runtime Assistant (CC-RA) which prompts the user to schedule appointments/events/collaboration based on correlations. The CC-RA may be used to dynamically schedule calendar events/reminders of users based on interests groups with the dimension of location and time, via a run-time framework.

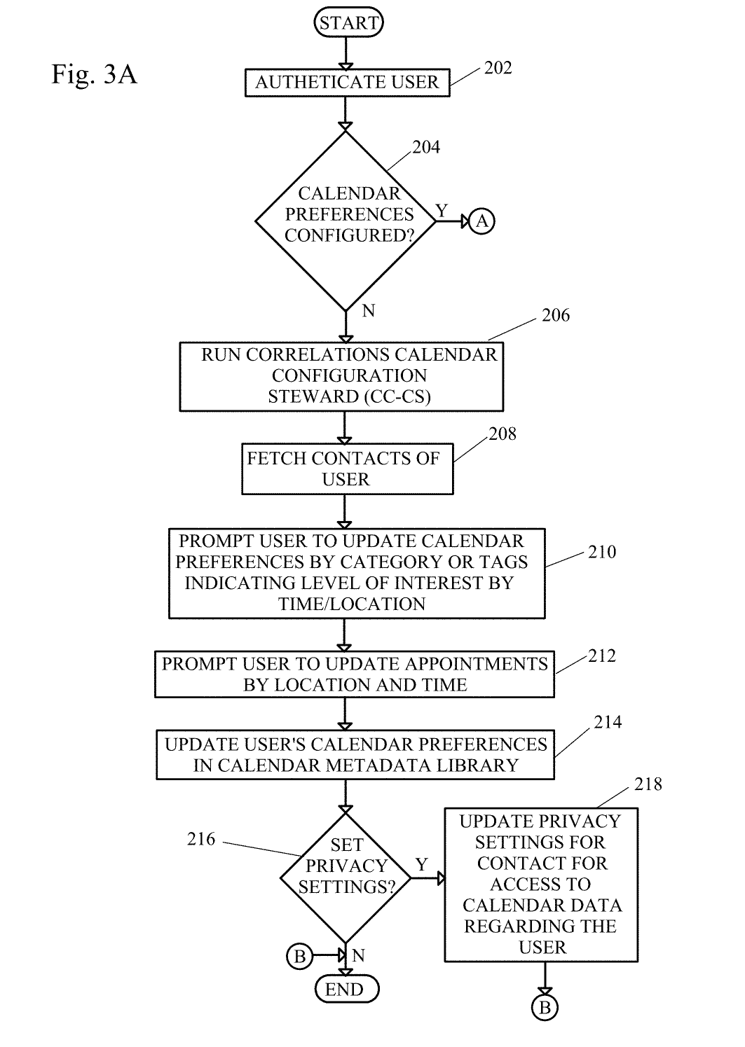

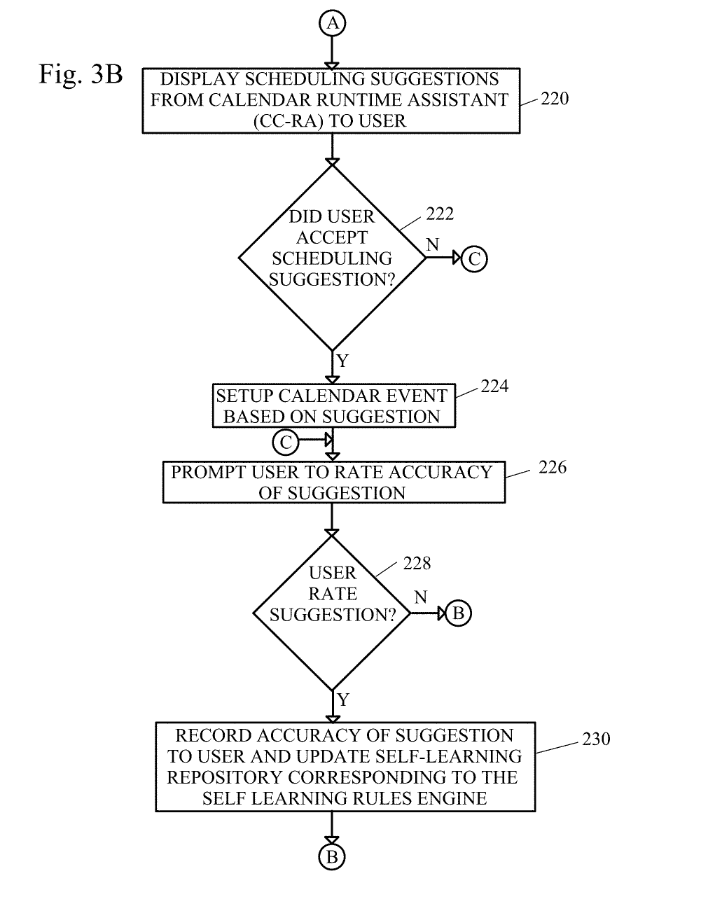

FIGS. 3A-3B show a flow diagram of a method of configuring and receiving suggestions. In a first step, a user is authenticated (step 202), for example by the dynamic scheduler program 66.

If the authenticated user does not have calendar preference configured (step 204), a correlations calendar configuration steward (CC-DS) is initiated (step 206), for example through the dynamic scheduler program 66.

The contacts of the authenticated user are retrieved (step 208). The contacts may be retrieved from a social network, group or other circles as established by the user.

The dynamic scheduler program 66 sends a prompt to a user to update calendar preferences by category or tags (step 210). The category or tabs indicating a level of interest of the user by time/location of the user.

The dynamic scheduler program 66 sends another prompt to a user to update the appointments by location and time (step 212). Other information associated with the appointments may also be updated, for example reminders and collaboration preferences.

Any categorization or tagging received from the user is used to update the user's calendar preferences in a calendar metadata library (step 214). For example, the tagging and categorization and any associated updates may be stored in a profile registry and meta-data library 110 of the multi-dimensional dynamic scheduler framework 100.

If the user does not wish to set the privacy settings for a contact or group of contacts (step 216), the method ends.

If the user does wish to set privacy settings for the user's contact or group of contacts (step 216), the privacy settings are provided by a user regarding the contact or the group of contacts access to the user's calendar (step 218) and the method ends. The privacy settings may be associated with a security and privacy controller 104 of the multi-dimensional dynamic scheduler framework 100.

Returning to step 204, if calendar preferences are already configured by the user, scheduling suggestions from the calendar runtime assistance (CC-RA) are displayed to the user (step 220). The calendar suggestions may be based on correlations provided from the framework 120 through the correlations identifier and mapper 108 of the multi-dimensional dynamic scheduler framework 100.

If the user accepts the scheduling suggestion (step 222), the calendar event is setup based on the approved or accepted suggestion (step 224).

A prompt may be sent to the user to rate the accuracy of the suggestions (step 226) regardless of whether the user accepted the scheduling suggestion. If the user rates the suggestion (step 228), the accuracy of the suggestions as supplied by the user is recorded (step 230) and is used to update a self-learning repository corresponding to the self-learning rules engine 112 of the multi-dimensional dynamic scheduler framework 100 and the method ends.

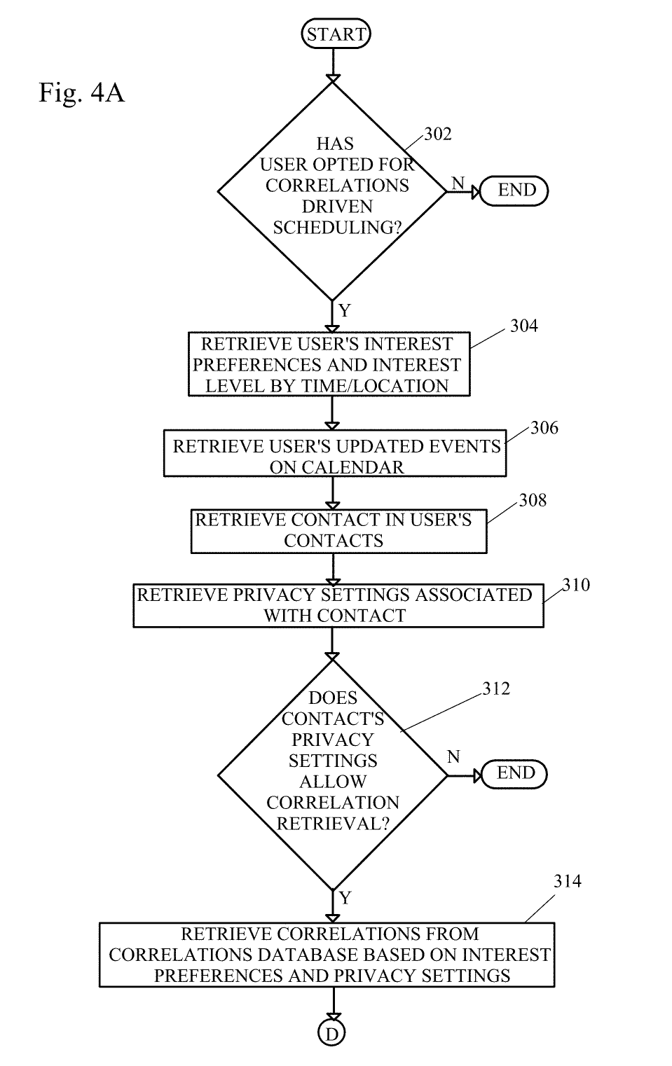

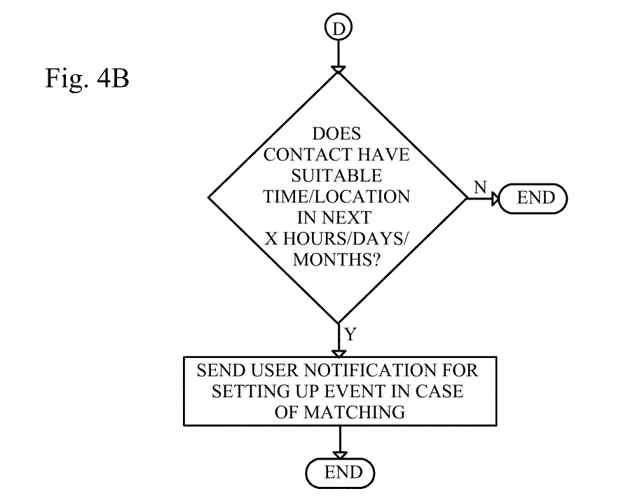

FIGS. 4A-4B show a flow diagram of a method of providing scheduling suggestions and may be steps that take place during step 220 of the method of FIGS. 3A-3B.

If the user has not chosen to receive correlation driven scheduling (step 302), the method of both FIGS. 3A-3B and 4A-4B ends.

If the user has chosen to receive correlation driven scheduling (step 302), the user's interest preferences and interest level by time and/or location is retrieved from a database or repository (step 304). For example, the preferences may be associated with the profile registry and meta-data library 110 of the multi-dimensional dynamic scheduler framework 100.

A user's updated appointments or events, which have been updated to include location and time as well as other information, for example reminders and collaboration preferences, are retrieved from a user's calendar (step 306), for example by the dynamic scheduler program 66.

A user's contacts associated with the updated events are retrieved (step 308). The information associated with contact, such as information regarding the contacts' interests and preferences may also be retrieved. The privacy settings associated with the contacts are then retrieved (step 310). If the contact's privacy settings allow correlation retrieval (step 312), correlations from a correlations database correlating the user's interests and preferences with the interests and preferences of the contact, as well as locations of the user and the contacts, for example a database or repository associated with the correlations identifier and mapper 108 of the multi-dimensional dynamic scheduler framework 100, may be retrieved (step 314).

If the contact has a suitable time/location in the next so many hours, days or months (step 316), a notification is sent to the user for setting up an event between the users (step 318).

If the contact's privacy settings do not allow correlation retrieval (step 312) or the contact does not have a suitable time/location in next so many hours, days, or months, the method ends.

In a first example, a corporate user 116, 118 receives dynamic appointments from an appoint scheduler 114, 115 based on availability, location and interested related to areas of work. The corporate user can set privacy settings as well as define boundaries on a GUI map which can be changed, for example through the dynamic map based scheduler 106. Based on the corporate user's preferences such as time slot availability, available location and areas of interests derived from the correlations identifier and mapper 108 of the multi-dimensional dynamic scheduler framework 100, scheduling suggestions would be provided for this user.

For example, Catherine is a Relationship/Account Manager for a medium-sized software product vendor and manages the vendor's relationship with 50+ clients. Catherine receives scheduling suggestions from the Correlations based Calendar Runtime Assistant (CC-RA) based on upcoming events, trips and program announcements/updates of various clients in which the vendor has accounts. Catherine may also receive suggestions for meetings with potential clients which may be in the area or at specific events, based on data collected from official and unofficial blogs, posts and feeds.

In another example, peer to peer appointment suggestions may be presented to users based on the user's location, and as defined by boundaries in the map, time slots during which user is available and user interests (as derived from correlations).

For example, Jeremy is a Personal Financial Advisor helping several higher-income professionals and salaried individuals manage their personal investments/finances. Jeremy relies on scheduling correlations received from the Correlations based Calendar Runtime Assistant (CC-RA) to derive numerous scheduling correlations based on his clientele's posts and inputs on social media, e-commerce and other online forums/portals, and providing him a head-start with regard to seeking his clientele's time/availability.

FIG. 5 illustrates internal and external components of device computer 52 and server computer 54 in which illustrative embodiments may be implemented. In FIG. 5, device computer 52 and server computer 54 include respective sets of internal components 800a, 800b and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, dynamic scheduler program 66 and data correlation program 67 are stored on one or more of the computer-readable tangible storage devices 830 for execution by one or more of the processors 820 via one or more of the RAMs 822 (which typically include cache memory). In the embodiment illustrated in FIG. 5, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. The dynamic scheduler program 66 and data correlation program 67 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. The dynamic scheduler program 66 and data correlation program 67 can be downloaded to the device computer 52, and the server computer 54 from an external computer via a network (for example, the Internet, a local area network or other, wide area network) and network adapter or interface 836. From the network adapter or interface 836, dynamic scheduler program 66 and data correlation program 67 is loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

The dynamic scheduler program 66 and data correlation program 67 can be written in various programming languages including low-level, high-level, object-oriented or non object-oriented languages. Alternatively, the functions of a dynamic scheduler program 66 and data correlation program 67 can be implemented in whole or in part by computer circuits and other hardware (not shown).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of configuring and providing suggestions for scheduling appointments for a user through a multi-dimensional dynamic scheduler framework connected to a data correlations framework which collects data from various sources comprising the steps of:
the computer retrieving a user's interests and preferences from a repository;
the computer retrieving a user's contacts and information regarding the contacts' interests and preferences from the repository;
the computer displaying scheduling suggestions to the user for appointments based on correlations between the user's interests and preferences and the interests and preferences of at least one of the user's contacts and locations of the user and the at least one contact; and
if the computer receives an acceptance of a scheduling suggestion, the computer scheduling the suggested appointment on the user's calendar.

2. The method of claim 1, wherein the step of the computer displaying scheduling suggestions to the user for appointments based on location and time further comprises the steps of:
the computer retrieving privacy settings associated with the contacts; and
the step of displaying scheduling suggestions is performed only if the contacts privacy settings allow correlation retrieval.

3. The method of claim 1, further comprising the steps of:
the computer requesting the user to update the user's preferences by category, indicating a level of interest by time and location, and storing the update to the user's preferences in the repository;
the computer requesting a user to update appointments by location and time and storing the updated appointments by location and time in the repository; and
the computer requesting the user to update to privacy settings for contacts access to calendar data of the user and storing the update to privacy settings in the repository.

4. The method of claim 1, wherein after the computer schedules the suggested appointment on the user's calendar, further comprising the steps of:
the computer requesting the user rate the suggested appointment for accuracy; and
the computer recording the user's rating of accuracy and storing the user's rating in the repository.

5. A computer program product configuring and providing suggestions for scheduling appointments for a user through a multi-dimensional dynamic scheduler framework connected to a data correlations framework which collects data from various sources with a computer comprising at least one processor, one or more memories, one or more computer readable storage media, the computer program product comprising a computer readable storage medium having program instructions embodied therewith, the program instructions executable by the computer to perform a method comprising:
retrieving, by the computer, a user's interests and preferences from a repository;
retrieving, by the computer, a user's contacts and information regarding the contacts' interests and preferences from the repository;
displaying, by the computer, scheduling suggestions to the user for appointments based on correlations between the user's interests and preferences and the interests and preferences of at least one of the user's contacts and locations of the user and the at least one contact; and
if the computer receives an acceptance of a scheduling suggestion, scheduling, by the computer, the suggested appointment on the user's calendar.

6. The computer program product of claim 5, wherein the program instructions of displaying, by the computer, scheduling suggestions to the user for appointments based on location and time further comprises the program instructions of:
retrieving, by the computer, privacy settings associated with the contacts; and
the program instructions of displaying, by the computer, scheduling suggestions is performed only if the contacts privacy settings allow correlation retrieval.

7. The computer program product of claim 5, further comprising the program instructions of:
requesting, by the computer, the user to update the user's preferences by category, indicating a level of interest by time and location, and storing the update to the user's preferences in the repository;
requesting, by the computer, a user to update appointments by location and time and storing the updated appointments by location and time in the repository; and
requesting, by the computer, the user to update to privacy settings for contacts access to calendar data of the user and storing the update to privacy settings in the repository.

8. The computer program product of claim 5, wherein after the program instructions of scheduling, by the computer, the suggested appointment on the user's calendar, further comprising the program instructions of:
requesting, by the computer, the user rate the suggested appointment for accuracy; and
recording, by the computer, the user's rating of accuracy and storing the user's rating in the repository.

9. A computer system for scheduling appointments for a user through a multi-dimensional dynamic scheduler framework connected to a data correlations framework which collects data from various sources comprising a computer comprising at least one processor, one or more memories, one or more computer readable storage media having program instructions executable by the computer to perform the program instructions comprising:
retrieving, by the computer, a user's interests and preferences from a repository;
retrieving, by the computer, a user's contacts and information regarding the contacts' interests and preferences from the repository;
displaying, by the computer, scheduling suggestions to the user for appointments based on correlations between the user's interests and preferences and the interests and preferences of at least one of the user's contacts and locations of the user and the at least one contact; and
if the computer receives an acceptance of a scheduling suggestion, scheduling, by the computer, the suggested appointment on the user's calendar.

10. The computer system of claim 9, wherein the program instructions of displaying, by the computer, scheduling suggestions to the user for appointments based on location and time further comprises the program instructions of:
retrieving, by the computer, privacy settings associated with the contacts; and
the program instructions of displaying, by the computer, scheduling suggestions is performed only if the contacts privacy settings allow correlation retrieval.

11. The computer system of claim 9, further comprising the program instructions of:
requesting, by the computer, the user to update the user's preferences by category, indicating a level of interest by time and location, and storing the update to the user's preferences in the repository;
requesting, by the computer, a user to update appointments by location and time and storing the updated appointments by location and time in the repository; and
requesting, by the computer, the user to update to privacy settings for contacts access to calendar data of the user and storing the update to privacy settings in the repository.

12. The computer system of claim 9, wherein after the program instructions of scheduling, by the computer, the suggested appointment on the user's calendar, further comprising the program instructions of:
requesting, by the computer, the user rate the suggested appointment for accuracy; and
recording, by the computer, the user's rating of accuracy and storing the user's rating in the repository.
